(19) United States
(12) Patent Application Publication
(10) Pub. No.: US 2014/0202063 A1
(43) Pub. Date: Jul. 24, 2014

(54) FISH MOUTH OPENING TOOL

(71) Applicant: John T. Webster, Branson, MO (US)

(72) Inventor: John T. Webster, Branson, MO (US)

(21) Appl. No.: 13/749,650

(22) Filed: Jan. 24, 2013

(51) Int. Cl. A01K 97/18

(52) U.S. Cl. CPC A01K 97/18
USPC 43/53.5

(57) ABSTRACT

A fishing tool is inserted into a fish's mouth to keep the mouth open while dislodging a fish hook therefrom. The fishing tool includes serrated arm teeth that can be opened when the handles are moved together. A clamping arch, with teeth, can keep the serrated arm teeth in an opened configuration and prevent closure while holding a fish's mouth open.

### BACKGROUND OF THE INVENTION

The present invention relates to fishing accessories and, more particularly, to a tool that can be inserted into a fish's mouth to open its mouth to access a fish hook.

When fishing, a fish hook can attach to a fish's mouth at various locations. Conventionally, a person has to handle the fish to keep it from moving while extracting the hook. In some circumstances, the hook may be embedded at a location inside the fish's mouth where it is difficult to access. Many times, the angler will cut the line and leave the hook inside the fish (where it dissolves), resulting in loss of the hook and the need to take the time to tie a new hook on the line.

If the hook is embedded in the fish's mouth, and the angler continues to try to remove it without having access to the hook, the fish can be injured and may not survive when released.

As can be seen, there is a need for a tool that can open a fish's mouth in a hands-free manner to provide access to a fish hook.

### SUMMARY OF THE INVENTION

In one aspect of the present invention, a fishing tool comprises a first finger ring arm; a first finger ring disposed on a first end of the first finger ring arm; a second finger ring arm; a second finger ring disposed on a first end of the second finger ring arm; serrated arm teeth disposed on an outer surface along the second, opposite end of the first finger ring arm and the second finger ring arm; and a pivot point pivotably securing the first finger ring arm to the second finger ring arm.

In another aspect of the present invention, a fishing tool comprises a first finger ring arm; a first finger ring disposed on a first end of the first finger ring arm; a second finger ring arm; a second finger ring disposed on a first end of the second finger ring arm, the second finger ring being larger than the first finger ring; serrated arm teeth disposed on an outer surface along the second, opposite end of the first finger ring arm and the second finger ring arm; a pivot point pivotably securing the first finger ring arm to the second finger ring arm; a clamping arch extending from the first finger arm; clamping arch teeth disposed along one edge of the clamping arch; and arm lock teeth disposed on the second finger arm, wherein the clamping arch teeth engage with the arm lock teeth to keep the serrated arm teeth separated a desired distance.

These and other features, aspects and advantages of the present invention will become better understood with reference to the following drawings, description and claims.

### BRIEF DESCRIPTION OF THE DRAWINGS

FIG. 1 is a perspective view of a fishing tool, in use, according to an exemplary embodiment of the present invention;

FIG. 2 is a perspective view of the fishing tool of FIG. 1 in a ready to use, serrated arm teeth closed, configuration;

FIG. 3 is a top view of the fishing tool of FIG. 2;

FIG. 4 is a perspective view of the fishing tool of FIG. 1 illustrating movement of the serrated arm teeth when moving the finger rings together;

FIG. 5 is a detailed perspective view of a portion of the fishing tool of FIG. 1, illustrating a clamping arch operable to prevent the serrated arm teeth from closing when opened inside a fish's mouth; and

FIG. 6 is an exploded perspective view of the fishing tool of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a fishing tool that is inserted into a fish's mouth to keep the mouth open while dislodging a fish hook therefrom. The fishing tool includes serrated arm teeth that can be opened when the handles are moved together. A clamping arch, with teeth, can keep the serrated arm teeth in an opened configuration and prevent closure while holding a fish's mouth open.

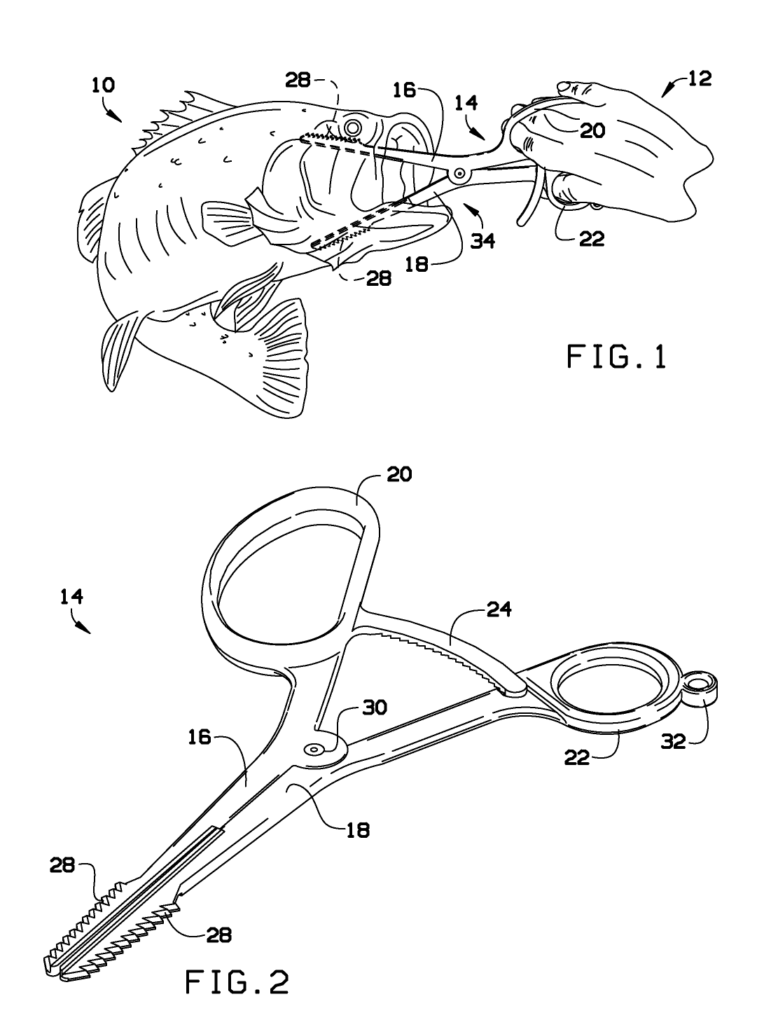

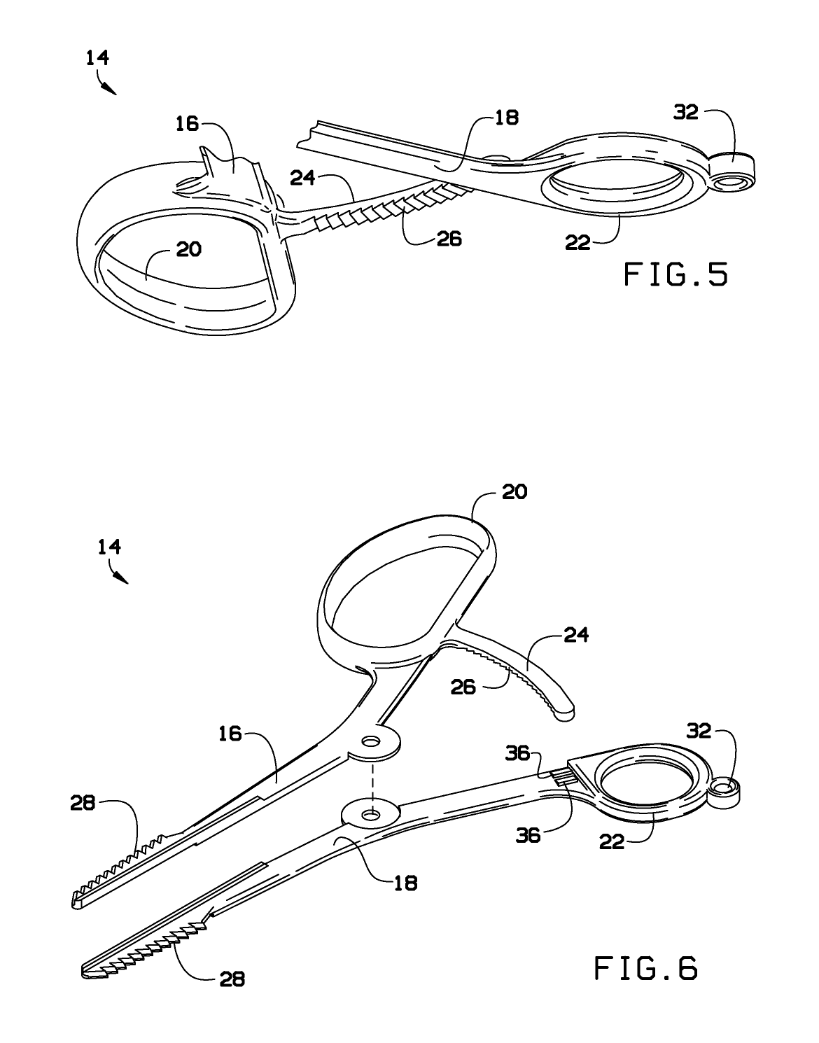

Referring to FIGS. 1 through 6, a fishing tool 14 can be inserted into a mouth 34 of a fish 10 by an angler 12 to hold the mouth 34 open while accessing a fish hook (not shown) from the fish's mouth 34.

The fishing tool 14 can include a large finger ring arm 16 and a small finger ring arm 18 pivotably held together with a pivot rivet 30. The large finger ring arm 16 and the small finger ring arm 18 can each include serrated arm teeth 28 on a first end thereof, and a large finger ring 20 and a small finger ring 22 on a second end thereof.

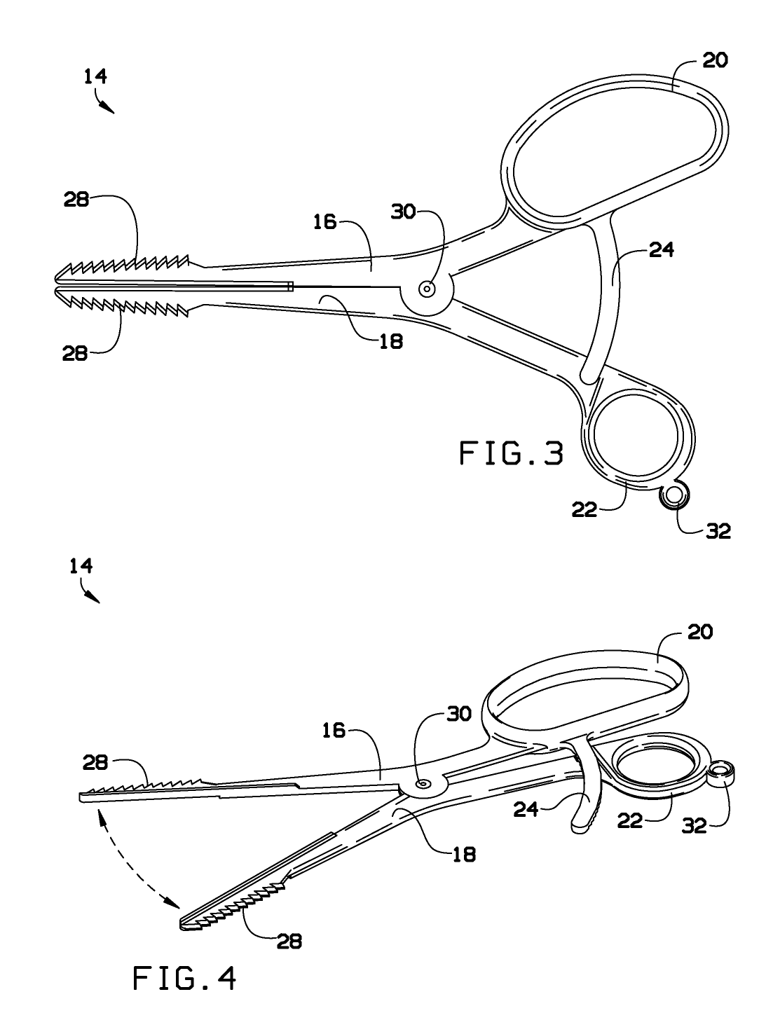

The serrated arm teeth 28 can be disposed on an outer surface of the large finger ring arm 16 and the small finger ring arm 18, while the inner surfaces thereof are flat. The flat surfaces of the large finger ring arm 16 and the small finger ring arm 18 can be disposed adjacent to each other when the fishing tool 14 is disposed in a closed, ready to use, configuration as shown in FIGS. 2 and 3. When the large finger ring 20 and the small finger ring 22 are moved together the serrated arm teeth 28 extend outward, as illustrated in FIG. 4. When the fishing tool 14 is disposed in the mouth 34 of the fish 10, the mouth 34 can be held open while the angler 12 removes the fish hook therefrom.

One of the large finger ring arm 16 and the small finger ring arm 18 can have a clamping arch 24 with clamping arch teeth 26 disposed thereupon. The other one of the large finger ring arm 16 and the small finger ring arm 18 can have arm lock teeth 36 disposed thereupon. When the large finger ring 20 and the small finger ring 22 are brought together, the clamping arch teeth 26 can freely move over the arm lock teeth 36 to open the serrated arm teeth 28. However, when a closing force is applied to the serrated arm teeth 28, the clamping arch teeth 26 engage with the arm lock teeth 36 to prevent the serrated arm teeth 28 from closing. Therefore, a user can open the serrated arm teeth 28 inside the fish's mouth 34 with one hand, then let go of the fishing tool 14, if necessary, to remove the hook, while the fishing tool 14 keeps the fish's mouth 34 open. In some embodiments, the clamping arch 24 can be disposed on the large finger ring arm 16 and the arm lock teeth 36 can be disposed on the small finger ring arm 18, as shown in the Figures. However, in some embodiments, the position of the clamping arch 24 and the arm lock teeth 36 can be reversed without affecting the function of the fishing tool 14. To move the serrated arm teeth 28 back into the closed, ready to use position after use, a user can move the large finger ring 20 and the small finger ring 22 to disengage the clamping arch teeth 26 from the arm lock teeth 36, allowing the serrated arm teeth 28 to move back to the closed position.

In some embodiments, the large finger ring 20 and the small finger ring 22 can be made with a round cross-section. Such a design can provide for user comfort and for suitable strength. In some embodiments, the large finger ring 20 and the small finger ring 22 can be flattened along an interior portion and rounded along the outer surface, such as a semi-circular cross-section.

A line eyelet 32 can be provided on at least one of the large finger ring 20 and the small finger ring 22. The line eyelet 32 can be used to secure the fishing tool 14 when not in use. While the Figures show the line eyelet 32 on the small finger ring 22, the line eyelet 32 could be disposed on the large finger ring 20 or on both.

The fishing tool 14 can be made from various materials, typically including a polymeric material, such as a material including about 80% fiberglass and 20% nylon. The rivet can be made of the same or different material, such as a plastic, nylon, fiberglass material, or combinations thereof, for example. The fishing tool 14 can be made in one or more sizes. Typically, the fishing tool 14 can be from about 8 to about 14 inches in length, for example.

The fishing tool 14 of the present invention can be used for additional purposes, in addition to gaining access to a fishing hook. For example, the fishing tool 14 can be used to hold the fish for skinning, filleting, cleaning or the like.

It should be understood, of course, that the foregoing relates to exemplary embodiments of the invention and that modifications may be made without departing from the spirit and scope of the invention as set forth in the following claims.

What is claimed is:

1. A fishing tool comprising:
a first finger ring arm;
a first finger ring disposed on a first end of the first finger ring arm;
a second finger ring arm;
a second finger ring disposed on a first end of the second finger ring arm;
serrated arm teeth disposed on an outer surface along the second, opposite end of the first finger ring arm and the second finger ring arm; and
a pivot point pivotably securing the first finger ring arm to the second finger ring arm.

2. The fishing tool of claim 1, wherein the first finger ring is larger than the second finger ring.

3. The fishing tool of claim 1, wherein the pivot point is secured by a fiberglass rivet.

4. The fishing tool of claim 1, further comprising:
a clamping arch extending from the first finger arm;
clamping arch teeth disposed along one edge of the clamping arch; and
arm lock teeth disposed on the second finger arm, wherein
the clamping arch teeth engage with the arm lock teeth to keep the serrated arm teeth separated a desired distance.

5. The fishing tool of claim 1, further comprising a line eyelet disposed on at least one of the first finger ring and the second finger ring.

6. A fishing tool comprising:
a first finger ring arm;
a first finger ring disposed on a first end of the first finger ring arm;
a second finger ring arm;
a second finger ring disposed on a first end of the second finger ring arm, the second finger ring being larger than the first finger ring;
serrated arm teeth disposed on an outer surface along the second, opposite end of the first finger ring arm and the second finger ring arm;
a pivot point pivotably securing the first finger ring arm to the second finger ring arm;
a clamping arch extending from the first finger arm;
clamping arch teeth disposed along one edge of the clamping arch; and
arm lock teeth disposed on the second finger arm, wherein
the clamping arch teeth engage with the arm lock teeth to keep the serrated arm teeth separated a desired distance.

7. The fishing tool of claim 6, wherein the pivot point is secured by a fiberglass rivet.

8. The fishing tool of claim 6, further comprising a line eyelet disposed on at least one of the first finger ring and the second finger ring.
